(19) United States
(12) Patent Application Publication
(10) Pub. No.: US 2021/0007289 A1
(43) Pub. Date: Jan. 14, 2021

(54) GROWING MEDIUM SUPPORT APPARATUS AND METHOD OF USE

(71) Applicant: Mike Steele, Apple Valley, CA (US)

(72) Inventor: Mike Steele, Apple Valley, CA (US)

(21) Appl. No.: 16/510,788

(22) Filed: Jul. 12, 2019

(51) Int. Cl. A01G 9/02; A01G 9/12; A01G 31/02

(52) U.S. Cl. CPC A01G 9/02; A01G 31/02; A01G 9/12

(57) ABSTRACT

The invention involves a growing medium support apparatus comprising a frame with a plurality of legs and an aperture. The aperture receives a first grow block, and the legs anchor the apparatus to a second grow block so that the second is situated and secured below the first. In exemplary embodiments, the frame of the apparatus is configured such that a bottom surface of the first grow block and a top surface of the second grow block touch to form at least a portion of a growing medium for a plant. As one grow block is placed on top of the other, a plant growing on the first grow block can expand its roots between the grow blocks secured together with the growing medium support apparatus. In some exemplary embodiments, multiple support apparatus may be utilized to secure multiple grow blocks to form a growing medium for the plant.

### TECHNICAL FIELD OF THE INVENTION

The present invention relates generally to horticultural tools and more specifically to a tool or apparatus for supporting a growing medium for plants.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

In certain horticultural systems, a plant may be grown by being planted on a growing medium other than soil. Such systems employ grow blocks, which may be made of a variety of materials and are often referred to as rock wool or stone wool. Horticultural systems that employ grow blocks typically require that plants be placed inside the grow block, which is used as a medium for introducing nutrients or plant food to the subject plant. Often, a plant that is very small (for example, a small clone) may be planted initially on a small grow block, and as the plant grows and its roots fill the grow block, the plant must be transplanted to a bigger grow block. To achieve the transplanting process, a hole may be cut into the larger grow block in order for the smaller grow block to fit inside the it. Once the grow blocks are merged, and as the plant grows, the roots of the plant will grow naturally into the larger grow block. In this way, the smaller grow block and the larger grow block become a single growing medium for the plant.

One problem with this approach is that the process is very labor intensive, since each transplanting process must be executed with each plant, and often a single plant may require transplanting several times. While effective when dealing with a single plant or even a few plants in a small garden, this approach becomes cumbersome, time-consuming and prohibitively expensive when dealing with horticultural systems involving hundreds or thousands of plants. Accordingly, it will greatly benefit the horticultural, agricultural, and similar industries if grow blocks could be connected together easily in a manner that facilitates the transplanting process mentioned above, while maintaining an adequate support for the plants being grown therein.

The prior art is crowded with support systems and devices for plants and soil, but no such support systems appear to be disclosed for a growing medium such as grow blocks. For example, horticultural systems that use plant support devices have been employed for centuries to help crops flourish. Some devices are designed for sheltering crops from inclement weather, while other devices are designed to support and hold up crops as they grow. Many teachings discuss systems that can be used for a variety of plants, according to the grower's need, but the prior art lacks teachings focusing on support devices designed specifically for growing mediums including grow blocks.

One system for supporting growing plants is disclosed by U.S. Pat. No. 3,113,400 to Emond (hereinafter referred to as “Emond”). Emond discloses a plant support system, which consists of a metal frame in a rectangular prism, with all sides open to the air. This system supports plants with fruits that are much heavier than the plant itself, such as tomatoes. Since the plant cannot both support its fruit and continue to grow upwards, this system is meant to provide the vertical support that the plant is lacking.

Another system is disclosed by U.S. Pat. No. 5,640,802 to Elliott (hereinafter referred to as “Elliott”). Tubes formed into hexagons are placed parallel to each other and to the ground, and are supported by straight, vertical tubes which interlock with each other. This provides a sturdy frame intended to support heavy plants.

A system similar to Elliott's is disclosed by U.S. Patent Application Publication 2011/0197502 to Morris (hereinafter referred to as “Morris”). Morris discloses a system which consists of flat, rectangular frames that are stacked parallel to the ground and are held up by four long spikes, one on each corner. Sets of these can be placed in a row and connected to each other, to support multiple individual plants of the same variety.

U.S. Pat. No. 8,006,433 to Bryanton (hereinafter referred to as “Bryanton”) takes a different approach by placing a semicircular base on the ground, with wires extending upwards. As the plants grow, they can be tied or clipped onto the wires. These semicircular bases can be attached to each other to form circles or other shapes as needed.

U.S. Patent Application Publication 2012/0017501 to Koopmeiners (hereinafter referred to as “Koopmeiners”) discloses a hollow rectangular prism of pipes that is affixed into the ground with stakes. Because the joints are held together with removable fittings, this system is adjustable to accommodate plants as they grow upwards.

U.S. Patent Application Publication 2015/0113869 to Brown (hereinafter referred to as “Brown”) builds upon earlier teachings by including square panels parallel to the ground and to each other, supported by a thin metal frame that is planted in the ground. The panels protect the young plant from inclement weather, and, when such protection is no longer needed, the panels can be removed, and the bare frame will support the plant as it continues to grow.

As the examples above illustrate, the prior art is riddled with devices that support plants. However, the prior art fails to disclose or address devices that provide support for growing mediums for plants such as grow blocks. Although the aforementioned systems do provide adequate support as the plant grows upwards, they do not eliminate the possibility of having to uproot and repot the plant. As a plant grows upwards, its roots grow downwards, and when roots grow too extensive for a limited growing medium, the plant may need to be transplanted. It is desirable to avoid transplanting, as it carries the risk of damaging the roots and possibly even killing the plant. With the present invention, a horticultural system can avoid transplanting by simply stacking the current growing medium on top of a larger one. This allows the roots to move naturally into the larger growing medium, and the plant can continue to grow without being disturbed.

It is to these ends that the present invention has been developed.

### SUMMARY OF THE INVENTION

To minimize the limitations in the prior art, and to minimize other limitations that will be apparent upon reading and understanding the present specification, the present invention describes an apparatus for supporting a growing medium for plants, and more specifically for supporting multiple grow blocks simultaneously.

Generally, a growing medium support apparatus in accordance with the present invention may comprise a frame with a plurality of legs and an aperture, wherein the aperture receives a first grow block therein and the legs anchor the apparatus to a second grow block so that the second grow block is situated and secured below the first grow block. In exemplary embodiments, the frame of the apparatus is configured such that a bottom surface of the first grow block and a top surface of the second grow block make contact to form at least a portion of a growing medium for a plant. As one grow block is placed on top of the other grow block, a plant growing on the first grow block can continue to grow, its roots enabled to expand between the grow blocks secured to each other with the growing medium support apparatus. In some exemplary embodiments, multiple support apparatuses may be utilized to secure multiple grow blocks to form a single growing medium for the plant.

A growing medium support apparatus, in accordance with exemplary embodiments of the present invention, may comprise a frame, including tapered side walls defined between a top edge and a bottom edge of the frame, and an aperture formed by the tapered side walls, the aperture configured to snugly receive a portion of a first grow block so that a bottom surface of the first grow block is substantially aligned with the bottom edge of the frame and exposed through a bottom portion of the aperture; and a plurality of legs extending below the bottom edge of the frame, each of the plurality of legs configured to anchor with a second grow block in a manner so that the bottom surface of the first grow block and a top surface of the second grow block make contact to form at least a portion of a growing medium for a plant.

According to some exemplary embodiments of the present invention, the frame is rectangular. The rectangular frame may include side walls defined between a top edge and a bottom edge of the rectangular frame, and a rectangular aperture defined by the side walls, the rectangular aperture configured to snugly receive a portion of a first grow block so that a bottom surface of the first grow block is substantially aligned with the bottom edge of the rectangular frame and exposed through a bottom portion of the rectangular aperture; and a plurality of legs extending below the bottom edge of the rectangular frame, each leg configured to anchor with a second grow block in a manner so that the bottom surface of the first grow block and a top surface of the second grow block make contact to form at least a portion of a growing medium for a plant.

Another growing medium support apparatus, in accordance with exemplary embodiments of the present invention, may comprise a rectangular frame, including side walls expanding between a top edge and a bottom edge of the rectangular frame, and a rectangular aperture defined by: a top opening defined by an interior perimeter of the top edge, the side walls, and a bottom opening defined by an interior perimeter of the bottom edge; wherein the rectangular aperture is configured to snugly receive a portion of a first grow block so that a bottom surface of the first grow block is substantially aligned with the bottom edge of the rectangular frame and exposed through a bottom portion of the rectangular aperture; and a plurality of legs, each of the plurality of legs extending below the bottom edge of the rectangular frame and configured to anchor with a second grow block in a manner so that the bottom surface of the first grow block and a top surface of the second grow block make contact to form at least a portion of a growing medium for a plant.

A growing medium support system, in accordance with exemplary embodiments of the present invention, may comprise a first grow block; a second grow block; and at least a first growing medium support apparatus, comprising: a rectangular frame, including side walls defined between a top edge and a bottom edge of the rectangular frame, and a rectangular aperture defined by the side walls, the rectangular aperture configured to snugly receive a portion of the first grow block so that a bottom surface of the first grow block is substantially aligned with the bottom edge of the rectangular frame and exposed through a bottom opening of the rectangular aperture; and a plurality of legs extending below the bottom edge of the rectangular frame, each of the plurality of legs anchors with the second grow block in a manner so that the bottom surface of the first grow block and a top surface of the second grow block make contact to form at least a portion of a growing medium for a plant.

A method for supporting a plurality of grow blocks that form a single growing medium for a plant, in accordance with exemplary embodiments of the present invention, may include the steps of (a) inserting a portion of a first grow block into an aperture of a growing medium support apparatus, wherein the growing medium support apparatus comprises a frame with a plurality of legs, the frame including side walls defined between a top edge and a bottom edge of the frame, the aperture defined in part by the side walls and configured to snugly receive the portion of the first grow block; (b) adjusting the first grow block inside the aperture so that a bottom surface of the first grow block is substantially aligned with the bottom edge of the frame and exposed through a bottom portion of the aperture; and (c) anchoring each of the plurality of legs of the growing medium support apparatus to a second grow block in a manner such that the bottom surface of the first grow block and a top surface of the second grow block make contact to form at least a portion of a growing medium for a plant.

Various objects and advantages of the present invention will become apparent from the following description taken in conjunction with the accompanying drawings, wherein are set forth, by way of illustration and example, certain embodiments of this invention. The drawings submitted herewith constitute a part of this specification, include exemplary embodiments of the present invention, and illustrate various objects and features thereof.

### BRIEF DESCRIPTION OF THE DRAWINGS

Elements in the figures have not necessarily been drawn to scale, in order to enhance their clarity and improve understanding of the various embodiments of the invention. Furthermore, elements that are known to be common and well understood to those in the industry are not depicted, in order to provide a clear view of the various embodiments of the invention. The drawings that accompany the detailed description can be described briefly as follows:

FIG. 1 illustrates a perspective view of one exemplary embodiment of a growing medium support apparatus and grow block in accordance with the present invention.

FIG. 2 illustrates a top view of one exemplary embodiment of a growing medium support apparatus in accordance with the present invention.

FIG. 3 illustrates a side view of one exemplary embodiment of a growing medium support apparatus in accordance with the present invention.

FIG. 4 illustrates a cross-sectional view of one exemplary embodiment of a growing medium support apparatus and grow block in accordance with the present invention.

FIGS. 5 illustrates a cross-sectional view of one exemplary embodiment of a growing medium support apparatus in accordance with the present invention.

FIG. 6 illustrates a perspective view of one exemplary embodiment of a growing medium support apparatus in accordance with the present invention.

FIG. 7 illustrates a cross-sectional view of one exemplary embodiment of a growing medium support apparatus in accordance with the present invention, shown supporting a first grow block and secured to a second grow block to form a growing medium for a plant.

FIG. 8 illustrates a cross-sectional view of one exemplary embodiment of a growing medium support system in accordance with the present invention, shown supporting a growing medium comprising a first grow block and a second grow block that form a growing medium for a plant.

FIG. 9 illustrates a cross-sectional view of one exemplary embodiment of a growing medium support system in accordance with the present invention, comprising multiple growing medium support apparatus for supporting multiple grow blocks that form a growing medium for a plant.

### DETAILED DESCRIPTION OF THE INVENTION

In the following discussion that addresses a number of embodiments and applications of the present invention, reference is made to the accompanying figures, which form a part thereof. Depictions are made, by way of illustration, of specific embodiments in which the invention may be practiced; however, it is to be understood that other embodiments may be utilized and changes may be made without departing from the scope of the present invention.

In the following detailed description, numerous specific details are set forth by way of example in order to provide a thorough understanding of the relevant teachings. However, it should be apparent to those skilled in the art that the present teachings may be practiced without such details. In other instances, well-known structures, components, and/or functional or structural relationship thereof, etc., have been described at a relatively high level, without detail, in order to avoid unnecessarily obscuring aspects of the present teachings.

Throughout the specification and claims, terms may have nuanced meanings suggested or implied in context beyond an explicitly stated meaning. Likewise, the phrase “in one embodiment/example,” as used herein, does not necessarily refer to the same embodiment. It is intended, for example, that the claimed subject matter include combinations of example embodiments in whole or in part.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments, whether these features, elements, and/or steps are included or are to be performed in any particular embodiment.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc., may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can include only A, some embodiments can include only B, some embodiments can include only C, and some embodiments can include A, B, and C. The term “and/or” is used to avoid unnecessary redundancy. Similarly, terms such as “a,” “an,” or “the,” again, may be understood to convey a singular usage or to convey a plural usage, depending at least in part upon context. In addition, the term “based on” may be understood as not necessarily intended to convey an exclusive set of facts and may, instead, allow of the existence of additional facts not necessarily expressly described, depending at least in part on context.

While exemplary embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the invention or inventions disclosed herein. Accordingly, the following detailed description does not limit the disclosure. Instead, the proper scope of the disclosure is defined by the appended claims.

As mentioned above, the present invention involves a growing medium support apparatus having a frame configured to support or secure at least two grow blocks together to form a single growing medium for a plant. In exemplary embodiments, the frame of the apparatus is configured such that a bottom surface of the first grow block and a top surface of the second grow block make contact to form at least a portion of the growing medium for the plant. As one grow block is placed on top of the other grow block, a plant growing on the first grow block can continue to grow, its roots enabled to expand between the grow blocks secured to each other with the growing medium support apparatus. In some exemplary embodiments, multiple support apparatus may be utilized to secure multiple grow blocks to form a single growing medium for the plant. The present invention avoids requiring traditional transplanting, and instead facilitates expansion of the growing medium of the plant by simply stacking and securing the current growing medium on top of a larger one. This configuration of multiple grow blocks allows the roots to move naturally from a first grow block into a second, typically larger grow block, so that the plant can continue to grow without being disturbed.

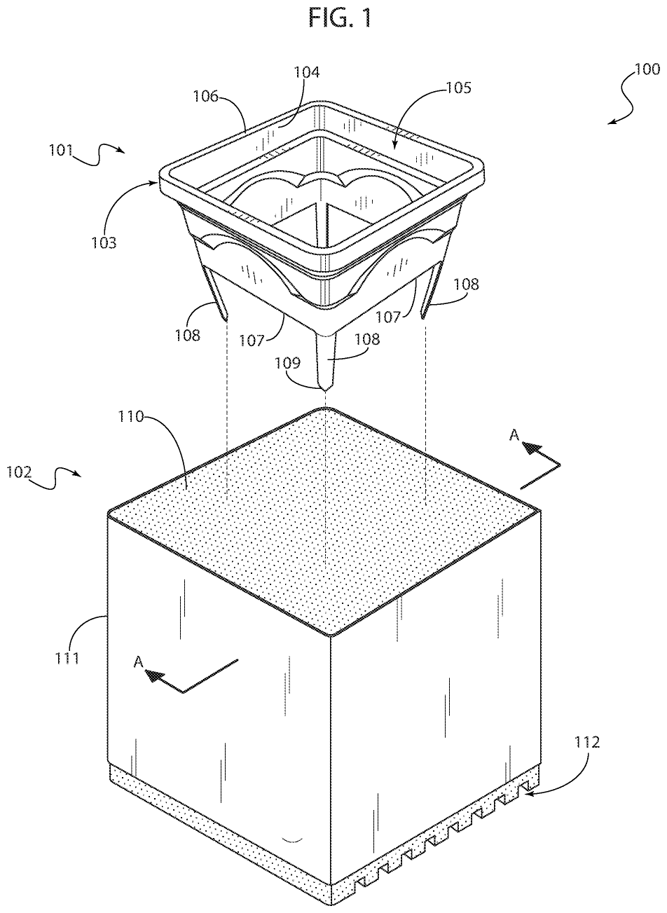

Turning now to the figures, FIG. 1 illustrates a perspective view of one exemplary embodiment of a growing medium support apparatus and grow block in accordance with the present invention. More specifically, FIG. 1 depicts components of a growing medium system 100, which include at least one growing medium support apparatus (apparatus 101) and a growing medium or grow block (grow block 102).

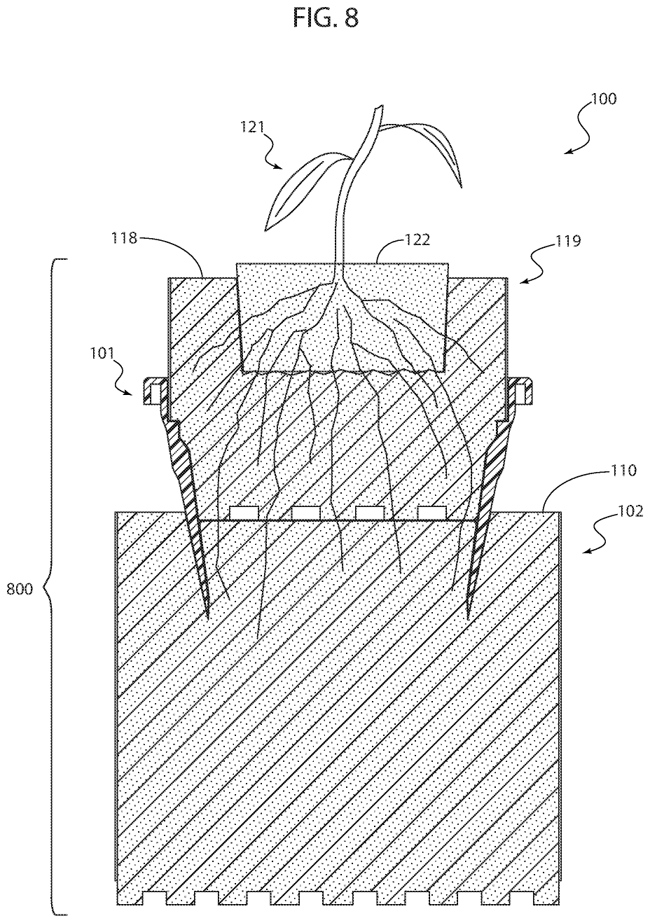

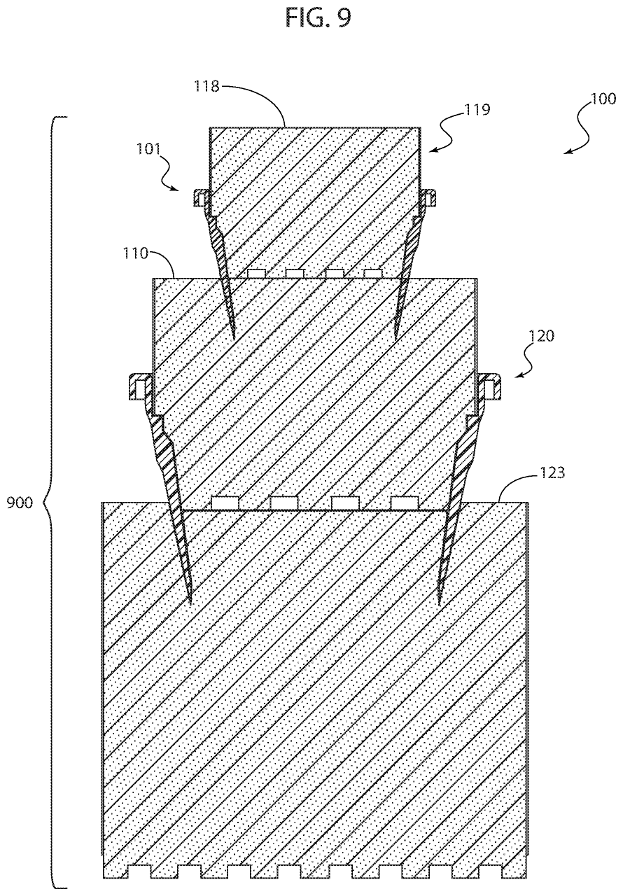

Apparatus 101 generally comprises a frame 103 having side walls 104 and an aperture 105 formed or bordered by the side walls 104, wherein aperture 105 is configured to receive a first grow block therein (the first grow block is not shown in this view but see FIG. 8 and FIG. 9). A plurality of legs 108 extend from a bottom portion of frame 103 and are configured to anchor apparatus 101 to a second grow block 102 so that the second grow block 102 is situated and secured below the first grow block. In exemplary embodiments, the frame 103 of apparatus 101 is configured such that a bottom surface of the first grow block and a top surface 110 of the second grow block 102 make contact to form at least a portion of a growing medium for a plant. As one grow block is placed on top of the other grow block, a plant growing on the first grow block can continue to grow, its roots enabled to expand between the grow blocks secured to each other with the growing medium support apparatus 101. In some exemplary embodiments, multiple support apparatus may be utilized to secure multiple grow blocks to form a growing medium for the plant.

Grow block 102 may be any typical growing medium for plants, including but not limited to a stone wool block or a rockwool block, as they are commonly referred to in the field. Generally, these grow media are made from molten rock that is spun into cotton-candy-like fibers and then compressed into cubes, blocks, or slabs. Typically, grow block 102 will have the capacity for absorbing nutrient solutions while retaining adequate oxygen for rapid plant growth. Grow block 102 may include a standard cover 111 and may also include grooves 112 at the base of grow block 102 to promote better drainage. Grow block 102 may be of any size—grow blocks in the industry typically come in graduated sizes so that seedlings or cuttings may be started on a smaller grow block, while larger grow blocks may be used for larger plants. Importantly, apparatus 101 may also come in a variety of sizes so as to accommodate seedlings or cuttings in smaller grow blocks as well as larger grow blocks suitable for later stages of a plant or larger plants in general.

Frame 103 may be constructed of a myriad of materials, including but not limited to plastic, metal, wood, ceramic, or any other suitable material, preferably one that is lightweight and durable. For example, and without limiting the scope of the present invention, frame 103 may comprise a plastic or plastic composite that may be constructed easily via injection mold methods, may be 3D-printed to the desired shape, or may be constructed using any other method suitable for creating a strong yet light frame 103. Regardless of the material from which frame 103 is constructed, frame 103 is generally configured to: receive a grow block at one end of the frame 103, and anchor with another grow block at another end of the frame. In exemplary embodiments, this is achieved by a frame that includes an aperture configured to receive a first grow block, and an anchoring means such as at least one leg extending from the frame, which may be inserted securely to a second grow block. Frame 103, for example, includes side walls 104 including a top edge 106 and a bottom edge 107.

Side walls 104 extend between top edge 106 and bottom edge 107 of frame 103, and form an enclosure or aperture 105 within an interior region of frame 103 that is configured to receive a grow block. Accordingly, although a shape of frame 103 may range from rectangular, or more specifically cubical, to even round, it is typical, and even preferable, for frame to be 103 shaped so as to receive universal sizes and shapes of commercially available grow blocks. As mentioned above, because the industry may include several universal sizes (ranging from smaller grow blocks to much larger grow blocks) frame 103 typically includes a rectangular or cubical shape, or more specifically side walls 104 that form an aperture 105 having a shape suitable for industry-available grow blocks. As will be discussed further below, in some exemplary embodiments, side walls 104 are tapered or narrow as they extend from top edge 106 to bottom edge 107. In some exemplary embodiments, side walls 104 are generally smooth, while in some exemplary embodiments side walls 104 may include ridges or protrusions that provide structural support but also a frictional element to facilitate securing a grow block inside aperture 105.

Aperture 105 is formed by side walls 104, as mentioned above. Generally, aperture 105 comprises two openings at opposite ends of frame 103, whereby a first opening may be a top opening defined by an inner or interior perimeter of top edge 106 of frame 103, and a second opening may be a bottom opening defined by an inner or interior perimeter of bottom edge 107 of frame 103. While side walls 104 are generally solid (for example as shown in the FIG. 1), in exemplary embodiments side walls 104 may comprise openings or the like without deviating from the scope of the present invention. As such, although aperture 105 generally includes only two openings, the side walls that form aperture 105 may include additional openings. However, whether side walls 104 include openings or slits (for example to provide breathing channels to a grow block secured therein), aperture 105 should be sturdy enough to secure the grow block within the side walls that form the aperture 105. Preferably, aperture 105 is sized so that at least the top opening of aperture 105 is only slightly larger than a grow block sized to fit inside aperture. 105 In this way, aperture 105 is configured to snugly receive a portion of a first grow block so that a bottom surface of the first grow block is substantially aligned with the bottom edge of the frame and exposed through the bottom opening of aperture 105.

Extending from bottom edge 107 of frame 103 is at least one leg 108 (or in the shown embodiment, a plurality of legs 108) configured to anchor with a second grow block in a manner such that the bottom surface of the first grow block and a top surface of the second grow block make contact to form at least a portion of a growing medium for a plant. In exemplary embodiments, frame 103 includes a plurality of legs 108 for anchoring into a grow block. However, in some exemplary embodiments, frame 103 may include only a single leg for anchoring into a grow block. In some exemplary embodiments that include a single leg, it may be appreciated that the single leg would need to be long enough toto provide the required stability and support so that the grow blocks stay secured in place and do not disrupt the growing medium of the subject plant. Preferably, exemplary embodiments would incorporate a plurality of legs 108 as shown in FIG. 1. Each of the plurality of legs 108 extends below the bottom edge 107 of the frame 103 and are configured to anchor with a top surface 110 of the second grow block 102. Each of the plurality of legs 108 extends from the bottom edge 107 of frame 103 so that each of the plurality of legs 108 points below and away from aperture 105. In exemplary embodiments, one or more of the plurality of legs 108 includes a pointed tip 109 configured to anchor the growing medium support apparatus 101 to the second grow block 102.

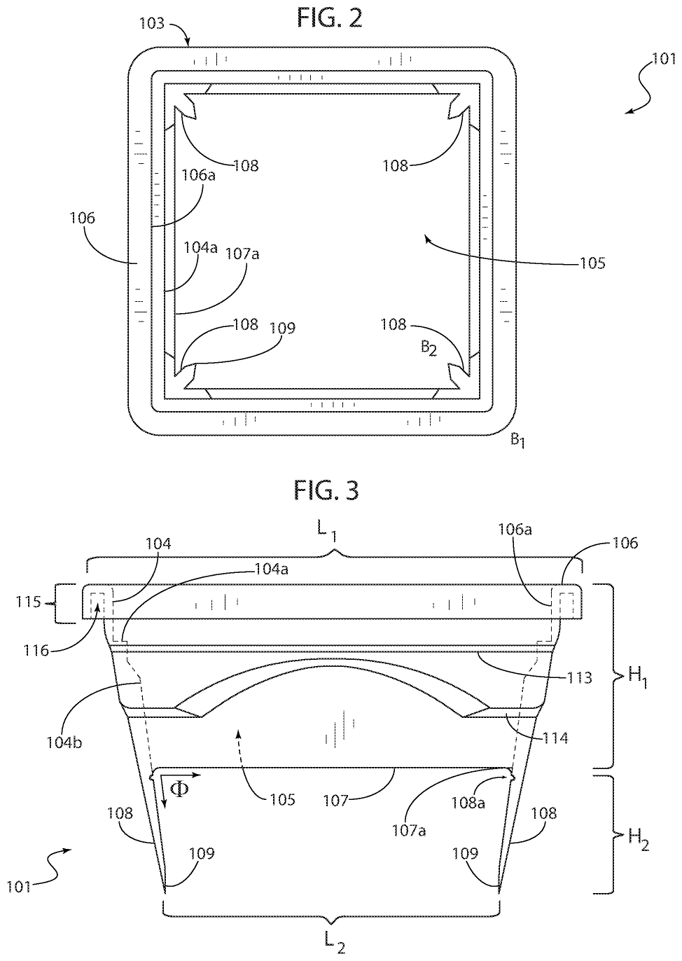

In exemplary embodiments, such as the embodiment depicted in FIG. 1-FIG. 3, frame 103 is rectangular. For example, and without limiting the scope of the present invention, frame 103 may comprise a substantially rectangular shape such that top opening 106a and bottom opening 107a of aperture 105 are squared openings (for example, see FIG. 2). Accordingly, in exemplary embodiments, apparatus 101 may comprise a rectangular frame 103, including side walls 104 expanding between top edge 106 and bottom edge 107 of rectangular frame 103. In such embodiment, aperture 105 is a rectangular aperture 105 defined by a top opening 106a formed within an interior perimeter of the top edge 106, the side walls 104, and a bottom opening 107a formed by an interior perimeter of the bottom edge 107; wherein the rectangular aperture 105 is configured to snugly receive a portion of a first grow block so that a bottom surface of the first grow block is substantially aligned with the bottom edge 107 of the rectangular frame 103 and exposed through the bottom opening of the rectangular aperture 105. Moreover, extending below the bottom edge 107 of the rectangular frame 103, legs 108 are configured to anchor with grow block 102 in a manner as discussed above.

Turning now to the next set of figures, FIG. 2 illustrates a top view of apparatus 101; and FIG. 3 illustrates a side view thereof. From these views, it may be appreciated that in exemplary embodiments, the top edge 106 of frame 103 may be generally smooth and flat; this provides a holding means that facilitates carrying a grow block secured within aperture 105—for example, when a plant is ready to be placed or coupled to a larger second or subsequent grow block. Moreover, from this top view it may also be appreciated that at least the interior of frame 103 is tapered or constructed in such a way that side walls 104 narrow so that a top perimeter of aperture 105 or top opening 106a is greater than a bottom perimeter of aperture 105 or bottom opening 107a.

In some exemplary embodiments, as shown in FIG. 2, side walls 104 may narrow between top opening 106a and bottom opening 107a in a stepped manner. That is, side walls 104 may include one or more steps 104a (see also FIG. 3) that form subsequent narrower perimeters from top to bottom of the side walls 104. In other exemplary embodiments, side walls 104 may be tapered or narrow smoothly without step structures in the interior of aperture 105.

Moreover, as may be also appreciated from the top view of FIG. 2 as well as the side view of FIG. 3, legs 108 may be angled towards a center or interior region B₂ below aperture 105; this angled configuration of legs 108 provides a better anchor and thus improved support mechanism when legs 108 of apparatus 101 are inserted into, for example, grow block 102.

FIG. 3 also illustrates how side walls 104 may be tapered so that top opening 106a of aperture 105 has an area greater than an area of bottom opening 107a of aperture 105. From the side view, it may be appreciated that the tapered frame includes a top length L₁ that is greater than a bottom length L₂. Furthermore, from this view, it may be appreciated that in some exemplary embodiments a height H₁ of side walls 104 may be greater than a height H₂ of each of the plurality of legs 108. Of course, in alternative embodiments, heights H₁ and H₂ may be substantially the same or height H₂ of side walls 104 may be less than a height H₂ of each of the plurality of legs 108, without deviating from the scope of the present invention, so long as side walls 104 provide adequate support to the grow block secured within aperture 105. Inadequate support would mean that a stacked grow block may fall easily and thus disrupt the growing medium for the subject plant. Moreover, this problem would be compounded in high volume operations in which hundreds or thousands of plants may require stacked growing media. Conversely, legs 108 should not be too long, so as to avoid interfering with the growing medium area of the lower grow block 102. Accordingly, in exemplary embodiments, the height H₁ of side walls 104 is slightly greater than a height H₂ of each of the plurality of legs 108 so as to provide adequate support to a grow block secured within aperture 105 of apparatus 101, and to provide an adequate length for legs 108 to anchor with a base grow block but not necessarily interfere with a growing medium area of the base grow block.

As briefly mentioned above, one optional structural component of apparatus 101 may include a rim lip 115 at a border of top edge 106 of frame 103. This rim lip 115 may be formed by a curved or bent terminal end of top edge, 106 bent downward so as to create a perimetrical cavity along an external perimeter of the top region of frame 103. This structure helps strengthen the top end of frame 103, which receives a grow block into aperture 105. Moreover, rim lip 115 provides a means to carry a grow block secured within aperture 105 from one place to another easily, and more importantly, a secured, strengthened structure that facilitates a user pushing down on the rim lip 115 in order to anchor apparatus adequately 101 to a base grow block such as grow block 102.

Yet another optional characteristic of frame 103 may include a ridged region 114 that adds structural support and rigidity to frame 103 situated on an outside surface of side walls 104 of frame 103 of apparatus 101.

FIG. 3 also depicts how legs 108 may be positioned such that each leg is at an acute angle ϕ in relation to bottom edge 107 of frame 103. Moreover, as better illustrated in the following figure, each leg may be optionally flexible so that each of the plurality of legs 108 may be moved independently about the bottom edge 107.

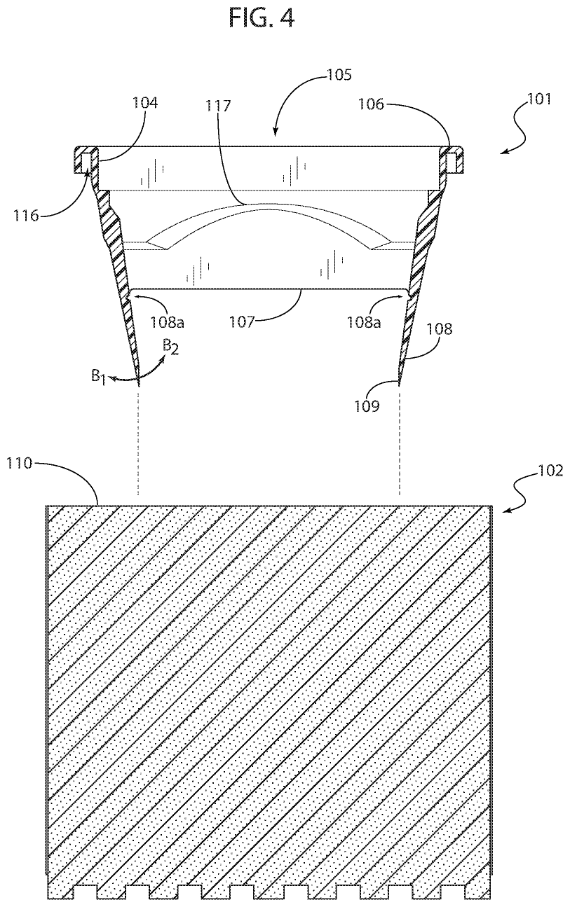

Turning now to FIG. 4, a cross-sectional view of apparatus 101 is illustrated over grow block 102, showing a number of optional structural features of the device in accordance with exemplary embodiments of the present invention. As briefly mentioned above, this view depicts how each leg 108 may be optionally flexible so that a position of each of the plurality of legs 108 may be independently moved about the bottom edge 107 towards an inner or interior region B₂ below aperture 105 and or towards an outer or exterior region B₁ external to, rather than below, aperture 105. For example, and without limiting the scope of the present invention, in an embodiment in which frame 103 comprises a plastic frame, each leg 108 may be constructed such that it is independently flexible. This may be achieved by, for example, including a nook 108a at each junction between leg 108 and bottom edge 107, which allows each leg 108 to be positioned between interior region B₂ and exterior region B₁ relative to aperture 105. This optional configuration facilitates inserting each leg 108 through a top surface 110 of grow block 102.

Another optional structural component depicted in this view includes rim lip 115, which was discussed above, as well as an interior ridged surface 117 that may be disposed along one or more interior side walls 104 of frame 103. In exemplary embodiments, ridged surface 117 may add yet another frictional component to side walls 104 within aperture 105 in order to secure a grow block therein.

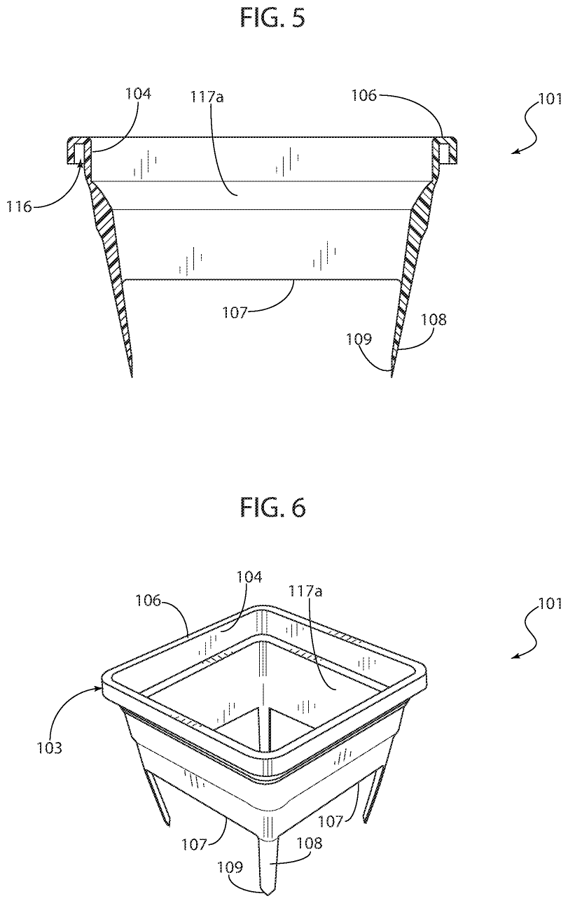

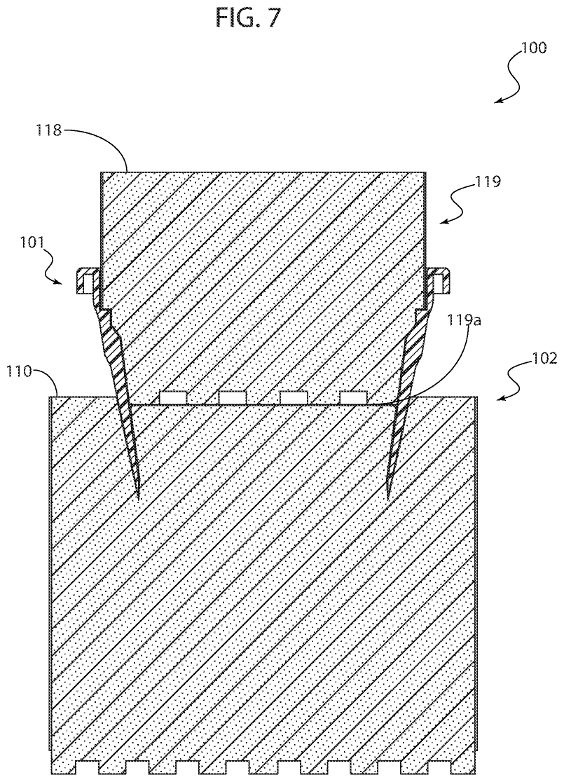

FIG. 5 illustrates a cross-sectional view of another exemplary embodiment of a growing medium support apparatus in accordance with the present invention, which does not include ridged surface 117 but instead includes an interior surface 117a of the side walls 104 that is substantially smooth. Similarly, FIG. 6 illustrates a perspective view of such embodiment of apparatus 101 wherein the exterior is also smooth (in contrast to the embodiment shown in FIG. 3, in which ridged region 114 is employed for additional structural support). That is, in the embodiments of apparatus 101 depicted in FIG. 5-6, frame 103 includes side walls that are substantially smooth.

The next figure depicts how apparatus 101 may be utilized in practice of exemplary embodiments of the present invention. More specifically, FIG. 7 illustrates a cross-sectional view of apparatus 101, shown supporting a first grow block 119 and secured to second grow block 102 to form a single growing medium for a plant. From this view, it may be appreciated that apparatus 101 may, in practice of exemplary embodiments of the present invention, be first coupled to grow block 119, which, although not shown in this view, typically may include a seedling, cutting, or otherwise small plant that has been growing or developing in grow block 119 and which may be ready for transplanting.

As such, in practice, a user may insert a portion of grow block 119 into aperture 105 of apparatus 101, wherein aperture 105 is configured to snugly receive the portion of grow block 119. That is typically enough to properly secure the grow block therein. As may be appreciated from this cross-sectional view, a user may further adjust grow block 119 inside the aperture 105 so that a bottom surface of grow block 119 is substantially aligned with the bottom edge 107 of the frame of apparatus 101 and exposed through the bottom opening of aperture 105.

Once grow block 119 is secured to apparatus 101 (at least partially inside aperture 105), a user may further anchor each of the plurality of legs 108 of apparatus 101 to grow block 102. Preferably, a user would press down on the apparatus 101 (for example at rim lip 115) so that each leg 108 is properly inserted through surface 110 and well into grow block 102. In exemplary embodiments, each leg 108 may be fully inserted into the base grow block 102. Moreover, because grow block 119 is exposed through the bottom opening to bottom edge 107 of apparatus 101, a user may adjust the grow blocks in a manner such that the bottom surface 119a of grow block 119 and a top surface 110 of grow block 102 make contact. In this way, grow block 119 and grow block 102 may be coupled to form at least a portion of a growing medium for the plant (not shown in this view) growing on grow block 119.

As mentioned above, this method avoids transplanting, and thus the risk of damaging the roots and possibly even killing the plant. With the present invention, a horticultural system can avoid transplanting by simply stacking the current growing medium on top of a larger one. This allows the roots to move naturally into the larger growing medium, and the plant can continue to grow without being disturbed. The next figure better illustrates the concept.

FIG. 8 illustrates a cross-sectional view of one exemplary embodiment of a growing medium support system in accordance with the present invention, shown supporting a growing medium 800 comprising a first grow block 119 and a second grow block 102 that form the growing medium 800 for plant 121. As mentioned above, seedlings started in cubes are easily transferred to blocks and then onto slabs, if desired. Seedlings or cuttings may be started on grow block 119 or even, as shown in this view, on a separate, smaller grow block 122. As such, an apparatus in accordance with this invention, and methods described herein are compatible with other commonly-used methods. That is, apparatus 101 may be used on grow blocks that have received a transplanted grow block such as shown in this view.

As illustrated by FIG. 8, growing medium support system 100, in accordance with exemplary embodiments of the present invention, may comprise a first grow block 119; a second grow block 102; and at least a first growing medium support apparatus 101, comprising: a rectangular frame 103, including side walls 104 defined between a top edge 106 and a bottom edge 107 of the rectangular frame 103, and a rectangular aperture 105 defined by the side walls 104, the rectangular aperture 105 configured to snugly receive a portion of the first grow block 119 so that a bottom surface 119a of the first grow block 119 is substantially aligned with the bottom edge 107 of the rectangular frame 103 and exposed through a bottom opening of the rectangular aperture 105; and a plurality of legs 108 extending below the bottom edge 107 of the rectangular frame 103, each of the plurality of legs anchored with the second grow block 102 in a manner so that the bottom surface 119a of the first grow block 119 and a top surface 110 of the second grow block 102 make contact to form at least a portion of a growing medium 800 for a plant 121.

As a plant may be desirably grown so that a yet larger growing medium may be required, a second apparatus similar to apparatus 101 may be employed as well in order to couple system 100 to yet another grow block and enlarge the growing medium 800. The next figure illustrates an embodiment of system 100 that does just that.

FIG. 9 illustrates a cross-sectional view of one exemplary embodiment of a growing medium support system 100 in accordance with the present invention, comprising multiple growing medium support apparatus for supporting multiple grow blocks that form a growing medium 900 for a plant. For the sake of focusing on the invention, the plant is not shown in this view. In this exemplary embodiment, growing medium support system 100 may include a second growing medium support apparatus 120 configured to: snugly receive a portion of the second grow block 102 so that a bottom surface of the second grow block 102 is substantially aligned with a bottom edge of a rectangular frame of the second growing medium support apparatus 120 and exposed through a bottom opening of the rectangular aperture of the second growing medium support apparatus 120; and anchored with a third grow block 123 in a manner such that the bottom surface of the second grow block 102 and a top surface of the third grow block 123 make contact to form at least a portion of growing medium 900 for the plant.

Accordingly, a method for supporting a plurality of grow blocks that form a single growing medium for a plant, in accordance with exemplary embodiments of the present invention, may include the steps of (a) inserting a portion of a first grow block into an aperture of a growing medium support apparatus, wherein the growing medium support apparatus comprises a frame with a plurality of legs, the frame including side walls defined between a top edge and a bottom edge of the frame, the aperture defined in part by the side walls and configured to snugly receive the portion of the first grow block; (b) adjusting the first grow block inside the aperture so that a bottom surface of the first grow block is substantially aligned with the bottom edge of the frame and exposed through a bottom portion of the aperture; and (c) anchoring each of the plurality of legs of the growing medium support apparatus to a second grow block in a manner so that the bottom surface of the first grow block and a top surface of the second grow block make contact to form at least a portion of a growing medium for a plant.

A growing medium support apparatus and method for implementing the same have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A growing medium support apparatus, comprising:
a rectangular frame, including side walls expanding between a top edge and a bottom edge of the rectangular frame, and a rectangular aperture defined by:
a top opening defined by an interior perimeter of the top edge,
the side walls, and
a bottom opening defined by an interior perimeter of the bottom edge;
wherein the rectangular aperture is configured to snugly receive a portion of a first grow block so that a bottom surface of the first grow block is substantially aligned with the bottom edge of the rectangular frame and exposed through a bottom portion of the rectangular aperture; and
a plurality of legs, each of the plurality of legs extending below the bottom edge of the rectangular frame and configured to anchor with a second grow block in a manner so that the bottom surface of the first grow block and a top surface of the second grow block make contact to form at least a portion of a growing medium for a plant.

2. The growing medium support apparatus of claim 1, wherein the side walls are tapered so that the top opening of the rectangular aperture has an area greater than an area of the bottom opening of the rectangular aperture.

3. The growing medium support apparatus of claim 1, wherein one or more of the plurality of legs is flexible.

4. The growing medium support apparatus of claim 1, wherein one or more of the plurality of legs includes a pointed tip configured to anchor the growing medium support apparatus to the second grow block.

5. The growing medium support apparatus of claim 1, wherein a height of the side walls is greater than a height of each of the plurality of legs.

6. The growing medium support apparatus of claim 1, wherein a height of the side walls is equal to a height of each of the plurality of legs.

7. The growing medium support apparatus of claim 1, wherein the top edge of the rectangular frame is smooth.

8. The growing medium support apparatus of claim 1, wherein the top edge of the rectangular frame comprises a rim lip.

9. The growing medium support apparatus of claim 1, wherein an interior surface of the side walls includes a ridged surface.

10. The growing medium support apparatus of claim 1, wherein an interior surface of the side walls is substantially smooth.

11. A growing medium support apparatus, comprising:
a frame, including tapered side walls defined between a top edge and a bottom edge of the frame, and an aperture formed by:
a top opening defined inner perimeter of the top edge of the frame,
the tapered side walls, and
a bottom opening defined by an inner perimeter of the bottom edge of the frame, wherein the aperture is configured to snugly receive a portion of a first grow block so that a bottom surface of the first grow block is substantially aligned with the bottom edge of the frame and exposed through the bottom opening of the aperture; and
at least one leg extending below the bottom edge of the frame configured to anchor with a second grow block in a manner so that the bottom surface of the first grow block and a top surface of the second grow block make contact to form at least a portion of a growing medium for a plant.

12. The growing medium support apparatus of claim 11, wherein the frame is a rectangular frame.

13. The growing medium support apparatus of claim 11, wherein the at least one leg is flexible.

14. The growing medium support apparatus of claim 11, wherein the at least one leg includes a pointed tip configured to anchor the growing medium support apparatus to the second grow block.

15. A growing medium support system, comprising:
a first grow block;
a second grow block; and
at least a first growing medium support apparatus, comprising:
a rectangular frame, including side walls defined between a top edge and a bottom edge of the rectangular frame, and a rectangular aperture defined by the side walls, the rectangular aperture configured to snugly receive a portion of the first grow block so that a bottom surface of the first grow block is substantially aligned with the bottom edge of the rectangular frame and exposed through a bottom opening of the rectangular aperture; and
a plurality of legs extending below the bottom edge of the rectangular frame, each of the plurality of legs that anchor with the second grow block in a manner so that the bottom surface of the first grow block and a top surface of the second grow block make contact to form at least a portion of a growing medium for a plant.

16. The growing medium support system of claim 15, further comprising a second growing medium support apparatus configured to:
snugly receive a portion of the second grow block so that a bottom surface of the second grow block is substantially aligned with a bottom edge of a rectangular frame of the second growing medium support apparatus and exposed through a bottom opening of a rectangular aperture of the second growing medium support apparatus; and
anchor with a third growing medium in a manner so that the bottom surface of the second grow block and a top surface of the third growing medium make contact to form at least a portion of the growing medium for the plant.

17. The growing medium support system of claim 16, wherein the side walls of the first growing medium support apparatus are tapered so that the top opening of the rectangular aperture has an area greater than an area of the bottom opening of the rectangular aperture.

18. The growing medium support system of claim 16, wherein one or more of the plurality of legs of the first growing medium support apparatus is flexible.

19. The growing medium support system of claim 16, wherein one or more of the plurality of legs of the first growing medium support apparatus includes a pointed tip configured to anchor the first growing medium support apparatus to the second grow block.

20. The growing medium support system of claim 16, wherein a height of the side walls of the first growing medium support apparatus is greater than a height of each of the plurality of legs of the first growing medium support apparatus.
